(19) United States
(12) Patent Application Publication
(10) Pub. No.: US 2013/0002525 A1
(43) Pub. Date: Jan. 3, 2013

(54) SYSTEM FOR LOCATING A POSITION OF AN OBJECT

(76) Inventor: Bobby Duane Foote, Hollister, CA (US)

(21) Appl. No.: 13/171,853

(22) Filed: Jun. 29, 2011

(51) Int. Cl. G09G 5/00; G01B 11/14; A42B 3/04

(52) U.S. Cl. 345/8; 2/410; 356/614

(57) ABSTRACT

A system is disclosed which includes a camera structured to detect an electromagnetic emission and a module to resolve the location of the object based upon the detected emission. In one form a scene captured by the camera can be filtered to highlight a wavelength, or range of wavelengths of interest. A helmet having a display coupled to it can be worn by an operator such as a pilot. A tracking device can be used to determine the orientation of the helmet relative to a vehicle and a module can be used to resolve the location of the object and indicate the position to the operator using the display. In one form the camera can be mounted to the operator's helmet. Multiple objects can be detected. Information about a position of an object can be relayed to other operators or systems.

### TECHNICAL FIELD

The present invention generally relates to resolving a location of an object, and more particularly, but not exclusively, to laser designation, detection, and display of a position of the object.

### BACKGROUND

Determining a location of an object from a moving vehicle remains an area of interest. Some existing systems have various shortcomings relative to certain applications. Accordingly, there remains a need for further contributions in this area of technology.

### SUMMARY

One embodiment of the present invention is a unique system for capturing a position of an object. Other embodiments include apparatuses, systems, devices, hardware, methods, and combinations for detecting a laser designation of an object and resolving a location of the object for display to an operator. Further embodiments, forms, features, aspects, benefits, and advantages of the present application shall become apparent from the description and figures provided herewith.

### BRIEF DESCRIPTION OF THE FIGURES

FIG. 1 depicts one embodiment of a system described herein.

FIG. 2 depicts an embodiment of an aircraft.

FIG. 3 depicts an embodiment of an operator and helmet.

FIG. 4 depicts one embodiment of a system.

FIG. 5 depicts an embodiment of a system.

FIG. 6 depicts an embodiment of symbology.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

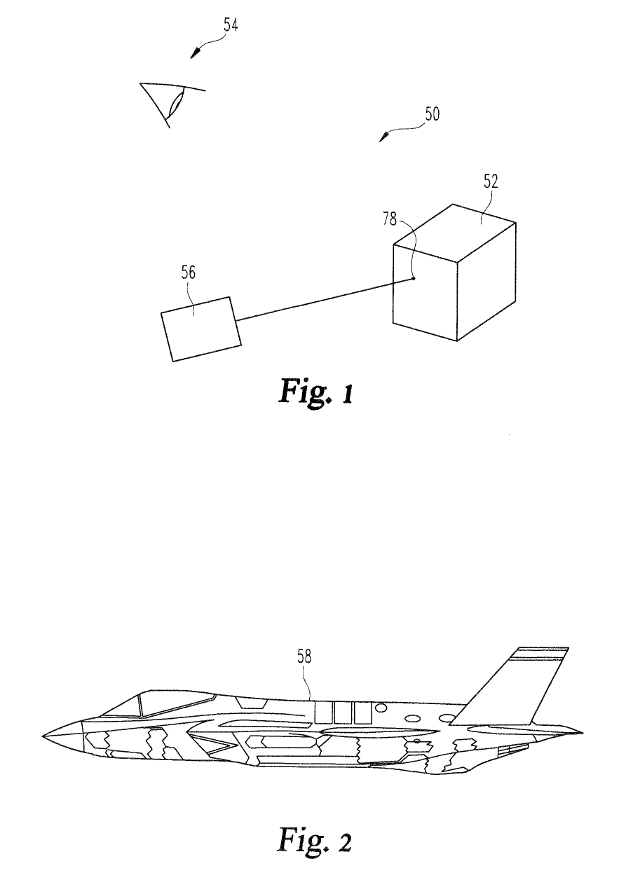

Shown in FIG. 1 is one embodiment of a system 50 useful for locating a position of an object 52. The location can be determined through the aid of a sensor 54 which is configured to detect an emission of electromagnetic energy from the object 52. In one embodiment the system 50 operates by employing a designator 56 that is used to direct an electromagnetic energy toward the object 52 which can be reflected by the object 52 and detected by the sensor 54. In one form the designator 56 is configured to emit coherent electromagnetic radiation. The designator 56 can be aimed at the object 52 via an operator (not shown) or other suitable device. In one embodiment the operator aims the designator 56 at the object 52 which is then “lased” or designated by the designator 56. The sensor 54 detects energy emitted from the object 52. The designator 56 can be hand-held or coupled to the body, carried into the field, and/or coupled with a vehicle such as an aircraft, among other possibilities. In one non-limiting form the designator 56 can be configured to emit electromagnetic wavelengths between 1000 nm and 1800 nm. In another non-limiting but more specific form, the designator 56 can be a targeting laser of 1064 nm or 1550 nm wavelengths. The sensor 54 can be hand-held or coupled to the body, carried into the field, and/or coupled with a vehicle among other possibilities. Various embodiments and features will be described further below.

As used herein, the term “aircraft” includes, but is not limited to, helicopters, airplanes, unmanned space vehicles, fixed wing vehicles, variable wing vehicles, rotary wing vehicles, autonomous aircraft, unmanned combat aerial vehicles, tailless aircraft, hover crafts, and other airborne and/or extraterrestrial (spacecraft) vehicles. Further, the present inventions are contemplated for utilization in other applications that may be coupled with vehicles other than aircraft such as, for example, ground vehicles, waterborne craft, and the like known to one of ordinary skill in the art.

Turning now to FIG. 2, one embodiment is disclosed of an aircraft 58 that can be used as a sensor to detect an electromagnetic emission from an object. The aircraft 58 can include one or more devices that serve as the sensor 54 useful in detecting the emitted electromagnetic radiation. Information sensed or derived from the sensor 54 can be displayed within the aircraft 58 and/or transmitted to a receiving device which can be located in another vehicle and/or located in a ground based facility, among other possibilities. The sensor 54 can be located in an external pod, hidden in an internal recess or space of the aircraft, or positioned in the cockpit, to set forth just a few non-limiting examples. In some forms the sensor 54 can be part of a larger system of sensors and/or computer processing devices. As used herein, a system can be representative of a single system or multiple systems in collaboration with each other. The system can be wholly independent or can be dependent upon another system.

The aircraft 58 can be used in a number of different roles to detect the position of an object. In one non-limiting example the aircraft 58 can be used in a war fighting role to detect the location of an object such as a building, military asset, or other important structure and may additionally be used to employ a weapon against the object. Outside of man-made structures, the object 52 can be a natural point of interest such as a bluff, valley, or other feature of terrain. The aircraft 58 can take a variety of forms such as a tactical fighter aircraft, a bomber, or a surveillance aircraft to name just a few variations. In some applications the aircraft 58 can be a search and rescue type of aircraft such as an air ambulance. The air ambulance can be dispatched to the scene of a rescue and/or recovery and can be used to locate a person in distress through the emission of electromagnetic radiation.

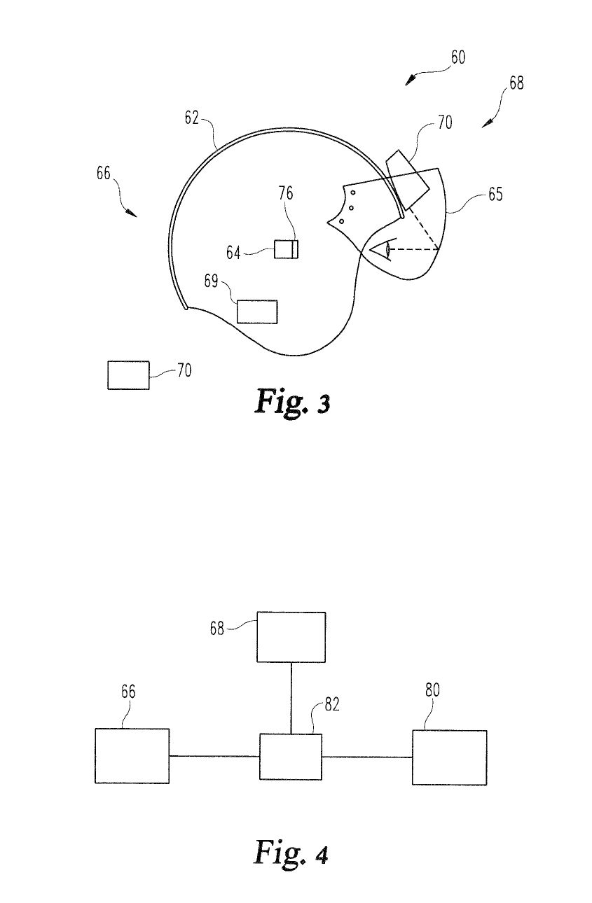

In the illustrated embodiment in FIG. 3, the aircraft 58 or other vehicle includes an occupant 60 that can be used alternatively or additionally to the aircraft 58 as part of the sensor 54 to detect electromagnetic energy from the object. In some embodiments the occupant 60 can be a crewmember such as a pilot tasked with operating the aircraft. For ease of convenience, the description below will make reference to a pilot but it will be appreciated that the description will be applicable to other crewmembers aboard the vehicle, whether the vehicle is an aircraft or not.

In the illustrated embodiment the pilot 60 wears a helmet 62 which can be used as protective covering and which is shown coupled with a camera 64 (discussed further below). The helmet 62 includes a visor 65 and a display system 68 capable of providing the pilot 60 with information useful to the maneuvering and navigation of the aircraft, among other alternative and/or additional types of information. In some forms the display system 68 is capable of integrating video and imagery which can be displayed to the pilot in either day or night operations. In one form the display system 68 is a helmet mounted display (HMD) capable of moving with the helmet as the pilot orients his or her head. In the illustrated embodiment the display system 68 includes a device 70 configured to project an image to the visor 65, but in other embodiments the display system 68 can incorporate one or more reticles or other devices useful for the display of information in lieu of the visor 65. In still other forms the display system 68 can include direct retinal projection. In some embodiments the device 70 of the display system 68 is a cathode ray tube which is coupled to suitable optical devices to project the display of information for the pilot. The pilot's field of view can extend past one or more portions of the visor 65 and/or reticles, but in some forms the visor 65 and/or reticles can extend beyond the pilot's field of view. Variations of the display system 68 other than those described above are contemplated herein.

The helmet 62 operates in conjunction with a tracking device 66 that can be used to determine the helmet 62 relative to a reference such as the aircraft 58. In one form the tracking device can determine a position and/or orientation of the helmet 62 relative to the aircraft. In some forms the position includes a location in three dimensional space and the orientation includes angles such as elevation, azimuth, and tilt. The tracking device 66 can take on a variety of forms as will be appreciated and in the illustrated embodiment includes a helmet mounted device 68 and an aircraft mounted device 70. The devices 69 and 70 can operate in conjunction to determine the helmet relative to the aircraft 58. The tracking device 66 can be structured to provide raw measurement information or calculated/derived values. The information provided by the tracking device 66 can be analog or digital. Though only a single device is shown mounted to the helmet 62 and aircraft 58, it will be appreciated that the devices 69 and 70 can include any number of devices operating together to determine the helmet relative to the aircraft 58. In one non-limiting form the tracking device 66 operates on basis of optical tracking. In yet another non-limiting form the tracking device 66 operates using electromagnetic tracking. Information from the tracking device 66 can be used in a variety of manners including the display of information to the display system 68. Additionally and/or alternatively, the information can be combined with information from the aircraft 58, and it can be communicated to other devices, among other possible uses.

The camera 64 attached to the helmet 62 can be used to capture a scene of electromagnetic energy and/or capture electromagnetic energy emitted from the object 52. The camera 64 can be affixed to the helmet 62 using a variety of techniques and in some embodiments a housing for the camera can be made integral with the helmet 62. The camera 64 can have a center of its field of view aligned with a center of the field of view of the display system 68. This alignment can be accomplished through mechanical mounting and electronic characterization. Not all embodiments need to have an exact alignment of the fields of view. Although only one camera 64 is depicted it will be appreciated that more than one can be provided in any given application. In some embodiments the camera 64 can be located elsewhere in the vehicle other than with the helmet 62. To set forth just one non-limiting example, the camera 64 can be located with an external store, such as for example a laser pod, connected to the vehicle. Other locations are contemplated herein. In some forms the camera 64 can be used to capture a visual image of a scene either inside or outside the vehicle 58 and can furthermore be configured to capture video and/or still image information of a scene. The camera 64 can include an image sensor such as a charge coupled device (CCD), complementary metal oxide semiconductor (CMOS), and the like for detecting images.

In one non-limiting form the camera 64, and/or information derived from the camera 64, can be used and/or configured to identify an electromagnetic energy from a specific part of the spectrum. For example, the camera 64 can be configured to detect short wave infrared radiation emitted from the object 52. In some embodiments information received by the camera 64 can be filtered to, for example, eliminate spectral ranges not of interest and/or enhance ranges that are of interest. In one non-limiting form the information can be filtered to maximize the signal of a targeting laser and reduce background noise. By way of non-limiting example only, the illustrated embodiment includes a bandpass filter 76 configured to pass a range of wavelengths and attenuate others. The bandpass filter 76 can be an optical filter that encounters the scene of electromagnetic energy captured and prior to it being received in a sensing element. In some forms the filter 76 can designed about the 1064 nm wavelength or the 1050 nm wavelength, as required to set forth just two non-limiting embodiments. The filter 76 can be implemented in a variety of techniques in addition to those described herein.

The camera 64 can be used to capture a designation of the object 52 with the designator 56. To set forth a non-limiting example, the camera 64 can be used to detect a “spot” 78 of laser energy emanating from the object 52. Such a spot can be a reflection from the object of a laser aimed at the object 52. In some embodiments of the present application the camera 64 can be used to capture multiple “spots” in a single scene. In some applications the spot or spots can be a reflection of a short wave infrared (SWIR) laser. The camera 64 can be configured to detect the SWIR laser reflection and in some forms the filter 76 can be used to enhance the laser and attenuate other wavelengths. The “spot” can be detected using the camera 64 in daylight, dawn, and dusk operations thus enabling greater flexibility of an operator to detect and locate a position of a designated object or objects. The camera 64 can alternatively and/or additionally be used during other time periods such as nighttime.

Turning now to FIG. 4, one embodiment of a system is disclosed in which the tracking device 66 and a vehicle's 58 information system 80 communicate information to a module 82 which integrates the information and provides it to the display system 68. The vehicle information system 80 is used to provide vehicle information such as position and orientation, among potential other data. The vehicle information system 80 can take the form of an inertial navigation system (INS), global positioning system (GPS) device, and integrated GPS/INS devices, among potential others, capable of generating roll, pitch, and heading angles, among other potentially useful information. The communication between the tracking device 66 and module 82, and/or the communication between the vehicle's information system 80 and the module 82, can take place via a communications bus such as a Mil-Std 1553 or Mil-Std 1773 bus, it can be transmitted via radiofrequency, or it can be shared via electronic memory, to set forth just three non-limiting examples.

The module 82 is configured to operate upon the information received from at least one of the camera 64, tracking device 66, and the vehicle information system 80 and resolve the location of the object 52 and/or provide information to the display system 68 regarding the object 52. In one non-limiting form the module 82 receives information about a laser “spot” relative to the field of view of the display system 68, it receives an orientation of the helmet 62 relative to the aircraft, and it receives an orientation of the aircraft 58 relative to the earth and then operates upon this information to produce a location of the “spot”. The module 82 can determine a position of the “spot” using direction cosine matrices and other algorithmic steps as may be needed to resolve its location. In some forms the module 82 can also receive information from devices such as laser range finders. In other additional/alternative forms the module 82 can be in communication with, or itself can store, relatively fixed information such as but not limited to a database to help resolve the location of the “spot”.

The location determined by the module 82 can take a variety of forms such as, but not limited to, a relative position, an absolute position, and derived information therefrom such as a bearing from the current location. To set forth just one non-limiting example, the position can be an orientation of the object relative to the vehicle such as, say, the ten o'clock position. Such relative information can be stored and, if the aircraft is maneuvering, indications of where to look to return to the object can be given to the pilot. For example, if the object position were captured, the display system 68 can provide cues to the pilot to return his/her gaze to the same general direction as previously detected. In some embodiments the position information can be determined as a latitude/longitude/altitude. To set forth just one non-limiting example, the latitude/longitude/altitude information can be derived from the camera 64, tracking device 66, and aircraft information. In one further non-limiting example, information from the camera 64, tracking device 66, and aircraft information can be coupled with a laser rangefinder to determine latitude/longitude/altitude. Other approaches to resolving position, whether of the latitude/longitude/altitude kind or the relative orientation kind, among others, are contemplated herein.

Though only one module 82 is shown in the illustrated embodiment, more than one module 82 can be used to communicate with various devices, integrate the information, and provide information to the display system 68. The module 82 can be comprised of digital circuitry, analog circuitry, or a hybrid combination of both of these types. Also, the module 82 can be programmable, an integrated state machine, or a hybrid combination thereof. The module 82 can include one or more Arithmetic Logic Units (ALUs), Central Processing Units (CPUs), memories, limiters, conditioners, filters, format converters, or the like which are not shown to preserve clarity. In one form, the module 82 is of a programmable variety that executes algorithms and processes data in accordance with operating logic that is defined by programming instructions (such as software or firmware). Alternatively or additionally, operating logic for the module 82 can be at least partially defined by hardwired logic or other hardware. It should be appreciated that module 82 can be exclusively dedicated to integrating information from the camera 64, tracking device 66, and/or the vehicle information system 80, or may further be used in the regulation/control/activation of one or more other subsystems or aspects of aircraft 58.

The communication between the module 82 and the display system 68 can take place via a communications bus such as a Mil-Std 1553 or Mil-Std 1773 bus, it can be transmitted via radiofrequency, or it can be shared via electronic memory, to set forth just three non-limiting examples. In some applications the module 82 can be integrated with any of the tracking device 66, vehicle information system 80, and/or the display system 68. To set forth just one non-limiting example, the module 82 can be located on a helmet with the display system 68.

The position of the object can be stored aboard the vehicle 58 and/or transmitted to other destinations. For example, the objects location can be transmitted to other vehicles or to a fixed ground based facility, to set forth just two non-limiting examples. In another non-limiting example the position of the object can be shared with a crewmember having a similar helmet 62 and display system 68. The location can be stored for later use and when desired a pointer can be provided to the display system 68 to indicate a direction in which either or both the helmet 62 and aircraft 58 can be turned to inspect the object 52.

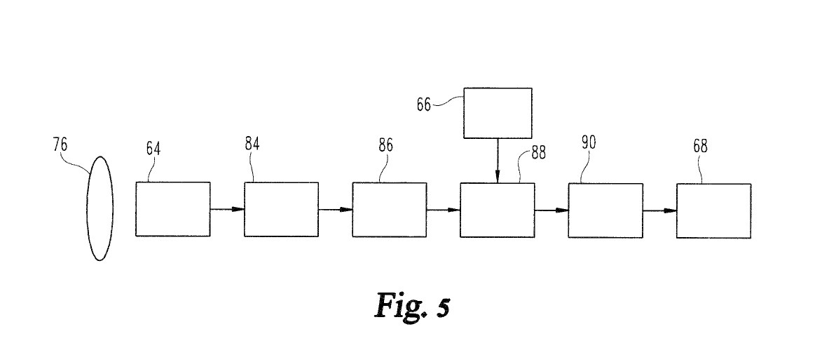

One non-limiting embodiment of the present application includes the depiction shown in FIG. 5. The system shown in the figure includes the filter 76, camera 64, tracking device 66, and the display system 68. A scene of electromagnetic energy is first filtered and the captured by the camera 64 which provides information of the scene to a procedure 84 structured to provide pixel/image processing. The procedure 84 can be an algorithm that processes the camera information to reduce noise and adjust white level to enhance the detected electromagnetic energy, such as a spot of laser energy discussed above. Upon being processed, the information captured by the camera is then subjected to a procedure 86 for spot detection processing. The procedure 86 can be implemented via an algorithm that is configured to pick out and/or isolate a laser spot, or spots, and provide the camera location of the spot(s). Information provided by the procedure 86 and the tracking device 66 is provided to procedure 88 for graphics processing. In one form the procedure 88 is used to create the symbology that provides the pilot the location of the designated object, or objects. Information from the procedure 88 is provided to a display driver 90 which can be a set of instructions allowing a computer to interact with the display system 68. An instruction set can include one or many instructions configured to operate upon information. The instruction set can be split among different modules. For example, an instruction set having many different operations can be hosted in separate machines and/or channels. Other variations are also contemplated herein. In one non-limiting form the display driver 90 can be a computer program that permits higher-level computer programs such as one form of procedure 88 to interact with the display system 68. As used herein, the term “procedure” includes a variety of techniques to implement the recited depiction. For example, the procedure can be one or more computer software routines coded to provide the steps described.

One or more of the procedures 84, 86, and 88 as well as the display driver 90 can be implemented in a module in a form such as that discussed above. Information can be shared among of the procedures 84, 86, and 88 as well as the display driver 90 in any variety of methods including via a communications bus such as a Mil-Std 1553 or Mil-Std 1773 bus, it can be transmitted via radiofrequency, or it can be shared via electronic memory, to set forth just three non-limiting examples.

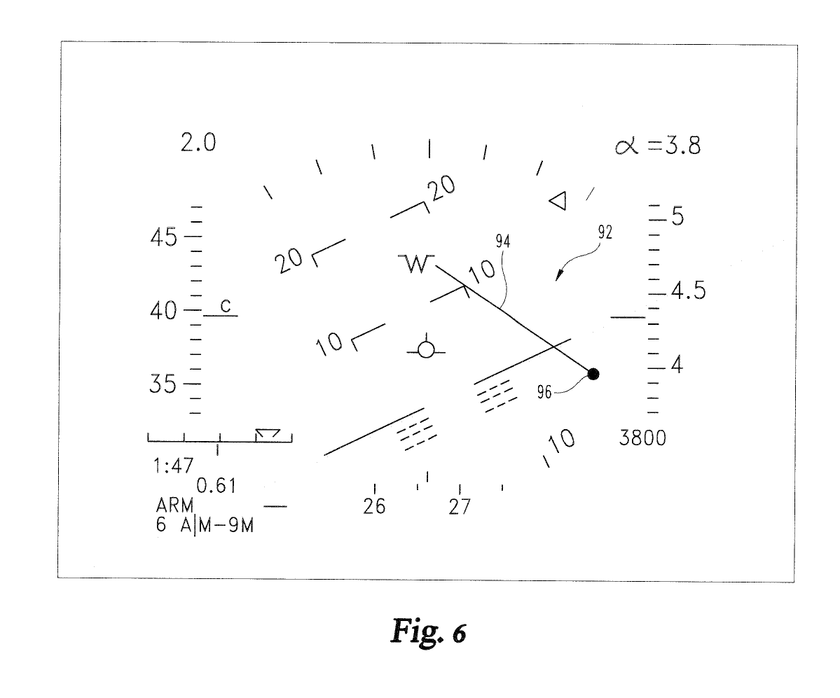

Turning now to FIG. 6, one embodiment is shown of a number of symbols which can be displayed to the pilot 60 using the display system 68. Such symbology can include altitude, airspeed, and heading, and the symbols depicted are merely representative of the types of symbology that can be shown with the display system 68. One embodiment of a symbol useful in cueing a pilot to a designated object is shown by reference numeral 92. The symbology 92 includes a lead line 94 to cue the pilot and a dot 96 at an end of the lead line 94 to indicate the location of the designated object. When multiple objects have been detected using the system described herein, the symbology can be the same for all objects. Alternatively, the symbology can have identifying characteristics unique to each object. The symbology can take on any variety of shapes, sizes, and colors, among other potential variations. The display system 68 can be capable of displaying the symbol with changes to any of its attributes, such as shape, size, and color, among others. In one non-limiting example, when a designated object is not within the field of view of the pilot, the symbology can be changed to indicate the object is outside of the field of view, as well as an indication of which way to look to acquire the object.

One aspect of the present application provides an apparatus comprising a helmet configured to be worn by an operator, an energy detector mounted to the helmet capable of sensing a concentration of electromagnetic energy in a scene of electromagnetic energy, a head tracker having a sensor capable of detecting a helmet orientation, and a module configured to determine a position of the concentration of electromagnetic information based upon the orientation of the helmet.

One feature of the present application which further includes a helmet mounted display coupled to the helmet and capable of projecting a symbol representative of the concentration of electromagnetic energy, and wherein the energy detector is configured to detect a laser energy reflected from an object of interest.

Another feature of the present application provides wherein the concentration of electromagnetic energy is a spot portion of the laser, and wherein the energy detector is capable of detecting electromagnetic energy at a wavelength between 1000 nm and 1800 nm, and which further includes a band filter structured to pass the reflected laser energy.

Yet another feature of the present application further includes a vehicle having an information system capable of determining at least one of a position and orientation of the vehicle, and which further includes a helmet mounted display configured to project a designation representative of the concentration of electromagnetic energy.

Still another feature of the present application provides wherein the energy detector is a short wave infrared camera.

Yet still another feature of the present application further includes an optical band pass filter structured to pass short wave infrared information.

Still yet another feature of the present application provides wherein the designation includes a pointer representative of a direction of the concentration of electromagnetic energy sensed by the energy detector relative to a field of view of the helmet mounted display, and wherein the module includes the capability to detect a spot of reflected electromagnetic energy.

Another aspect of the present application provides an apparatus comprising a vehicle having an information system capable of determining an orientation of the vehicle, a helmet having a helmet mounted display, a tracker structured to detect relative orientation of the helmet and vehicle, a sensor capable of detecting electromagnetic energy reflected from an object illuminated by an electromagnetic energy source, and a module configured to operate upon information of the reflected electromagnetic energy and information from the tracker and to provide a signal representative of the object, the signal useful to a display of the object from the helmet mounted display.

Still another feature of the present application provides wherein the vehicle is an aircraft and wherein the helmet mounted display includes the capability to present a symbol representative of the illuminated object, wherein the illuminated object is a designated target.

Yet still another feature of the present application provides wherein the sensor is a camera and the object is a target designated by the electromagnetic energy source.

Still yet another feature of the present application provides wherein the electromagnetic energy includes a wavelength between 1000 nm and 1800 nm.

A further feature of the present application further includes a bandpass filter operable to pass a select range of electromagnetic wavelengths, and wherein the head tracker is capable of detecting an orientation of the helmet.

A still further feature of the present application provides wherein the camera is connected to the helmet having the helmet mounted display.

A yet further feature of the present application provides wherein the camera includes an optical filter structured to minimize a background noise and improve a signal of a targeting laser.

Still yet a further feature of the present application provides wherein the instruction set is also configured to operate upon at least one of the orientation and a position of the vehicle.

Yet still another feature of the present application further includes a communication device capable of transmitting the information of the illuminated object outside of the aircraft.

Yet another aspect of the present application provides an apparatus comprising a helmet having a helmet mounted display, a camera structured to detect short wave infrared wavelengths, and means for locating a laser designated target based upon an orientation of the helmet and information from the camera.

A feature of the present application provides wherein the means includes means for resolving relative orientation of the helmet and a vehicle.

Another feature of the present application provides wherein the helmet mounted display is configured to display a symbol based upon the means for locating a laser designated target.

Still another aspect of the present application provides a method comprising receiving a scene of electromagnetic energy with an optical device, sensing an electromagnetic energy reflected from an object with a detector structured to sense electromagnetic energy, determining an orientation of a helmet using a tracker, and resolving a location of the object based upon the sensing the electromagnetic energy and the determining an orientation of a helmet.

A feature of the present application provides wherein the sensing includes capturing a reflected laser wavelength between 1000 nm and 1800 nm, and which further includes filtering the electromagnetic energy.

Another feature of the present application provides wherein the filtering includes reducing background noise and relatively heightening a spot portion, and which further includes projecting a symbol representative of a target lased with electromagnetic energy using a helmet mounted display.

Yet another feature of the present application further includes determining a relative position of a helmet and a vehicle with a helmet tracker.

Still yet another feature of the present application further includes isolating the object based upon the sensed electromagnetic energy to identify a spot portion of the electromagnetic energy representative of a lased target, and operating on the relative position of the helmet and the spot portion to determine a location within a field of view of the helmet mounted display to project a symbol.

Yet still another feature of the present application further includes cuing an operator to a direction of the lased target when the spot portion is outside of the field of view of the helmet mounted display.

A further feature of the present application provides wherein the sensing occurs onboard an aircraft, and which further includes communicating information of the lased target to a system outside of the aircraft.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus comprising:
a helmet configured to be worn by an operator;
an energy detector mounted to the helmet capable of sensing a concentration of electromagnetic energy in a scene of electromagnetic energy;
a head tracker having a sensor capable of detecting a helmet orientation; and
a module configured to determine a position of the concentration of electromagnetic information based upon the orientation of the helmet.

2. The apparatus of claim 1, which further includes a helmet mounted display coupled to the helmet and capable of projecting a symbol representative of the concentration of electromagnetic energy, and wherein the energy detector is configured to detect a laser energy reflected from an object of interest.

3. The apparatus of claim 2, wherein the concentration of electromagnetic energy is a spot portion of the laser, and wherein the energy detector is capable of detecting electromagnetic energy at a wavelength between 1000 nm and 1800 nm, and which further includes a band filter structured to pass the reflected laser energy.

4. The apparatus of claim 1, which further includes a vehicle having an information system capable of determining at least one of a position and orientation of the vehicle, and which further includes a helmet mounted display configured to project a designation representative of the concentration of electromagnetic energy.

5. The apparatus of claim 4, wherein the energy detector is a short wave infrared camera.

6. The apparatus of claim 5, which further includes an optical band pass filter structured to pass short wave infrared information.

7. The apparatus of claim 5, wherein the designation includes a pointer representative of a direction of the concentration of electromagnetic energy sensed by the energy detector relative to a field of view of the helmet mounted display, and wherein the module includes the capability to detect a spot of reflected electromagnetic energy.

8. An apparatus comprising:
a vehicle having an information system capable of determining an orientation of the vehicle;
a helmet having a helmet mounted display;
a tracker structured to detect relative orientation of the helmet and vehicle;
a sensor capable of detecting electromagnetic energy reflected from an object illuminated by an electromagnetic energy source; and
a module configured to operate upon information of the reflected electromagnetic energy and information from the tracker and to provide a signal representative of the object, the signal useful to a display of the object from the helmet mounted display.

9. The apparatus of claim 8, wherein the vehicle is an aircraft and wherein the helmet mounted display includes the capability to present a symbol representative of the illuminated object, wherein the illuminated object is a designated target.

10. The apparatus of claim 8, wherein the sensor is a camera and the object is a target designated by the electromagnetic energy source.

11. The apparatus of claim 10, wherein the electromagnetic energy includes a wavelength between 1000 nm and 1800 nm.

12. The apparatus of claim 10, which further includes a bandpass filter operable to pass a select range of electromagnetic wavelengths, and wherein the tracker is capable of detecting an orientation of the helmet.

13. The apparatus of claim 10, wherein the camera is connected to the helmet having the helmet mounted display.

14. The apparatus of claim 13, wherein the camera includes an optical filter structured to minimize a background noise and improve a signal of a targeting laser.

15. The apparatus of claim 8, wherein the module is also configured to operate upon at least one of the orientation and a position of the vehicle.

16. The apparatus of claim 15, which further includes a communication device capable of transmitting the information of the illuminated object outside of the aircraft.

17. An apparatus comprising:
a helmet having a helmet mounted display;
a camera structured to detect short wave infrared wavelengths; and
means for locating a laser designated target based upon an orientation of the helmet and information from the camera.

18. The apparatus of claim 17, wherein the means includes means for resolving relative orientation of the helmet and a vehicle.

19. The apparatus of claim 18, wherein the helmet mounted display is configured to display a symbol based upon the means for locating a laser designated target.

20. A method comprising:
receiving a scene of electromagnetic energy with an optical device;
sensing an electromagnetic energy reflected from an object with a detector structured to sense electromagnetic energy;
determining an orientation of a helmet using a tracker; and
resolving a location of the object based upon the sensing the electromagnetic energy and the determining an orientation of a helmet.

21. The method of claim 20, wherein the sensing includes capturing a reflected laser wavelength between 1000 nm and 1800 nm, and which further includes filtering the electromagnetic energy.

22. The method of claim 21, wherein the filtering includes reducing background noise and relatively heightening a spot portion, and which further includes projecting a symbol representative of a target lased with electromagnetic energy using a helmet mounted display.

23. The method of claim 20, which further includes determining a relative position of a helmet and a vehicle with a helmet tracker.

24. The method of claim 23, which further includes isolating the object based upon the sensed electromagnetic energy to identify a spot portion of the electromagnetic energy representative of a lased target, and operating on the relative position of the helmet and the spot portion to determine a location within a field of view of the helmet mounted display to project a symbol.

25. The method of claim 24, which further includes cuing an operator to a direction of the lased target when the spot portion is outside of the field of view of the helmet mounted display.

26. The method of claim 20, wherein the sensing occurs onboard an aircraft, and which further includes communicating information of the lased target to a system outside of the aircraft.
